(19) United States
(12) Patent Application Publication
(10) Pub. No.: US 2005/0250379 A1
(43) Pub. Date: Nov. 10, 2005

(54) Hole adapter for a printed circuit board

(75) Inventor: Joseph C. Coffey, Burnsville, MN (US)

Correspondence Address: Merchant & Gould P.C., P.O. Box 2903, Minneapolis, MN, 55402-0903, US

(73) Assignee: ADC Telecommunications, Inc.

(21) Appl. No.: 10/839,993

(22) Filed: May 5, 2004

(51) Int. Cl. H01R 13/73

(52) U.S. Cl. 439/544

(57) ABSTRACT

A coupler mounting arrangement including an adapter configured to mount to a printed circuit board. The arrangement adapts a circular hole formed in the printed circuit board to a non-circular through hole configured for receipt of a coupler. The arrangement axially and rotationally secures the coupler in relation to the printed circuit board. The adapter may be configured to provide electrical connectively as well as provide structural mounting stability.

### TECHNICAL FIELD

This disclosure relates generally to methods and devices for holding couplers. More particularly, this disclosure relates to an adapter and mounting arrangement for holding copper or optical telecommunications couplers on a sheet structure.

### BACKGROUND

A wide variety of arrangements have been utilized for mating telecommunication couplers. Generally, the couplers include mating couplers mounted in a through hole formed in a sheet structure. In some applications the sheet structure is a sheet metal support. The through holes formed in the sheet metal are sometimes punched or milled with a keyed configuration, such as a D-shape configuration, that maintains the orientation of the coupler when mounted to the sheet metal.

In other applications, the sheet structure is a printed circuit board. Because of the material characteristics of circuit boards, the through holes are formed by a drilling operation. Milling and punching operations typically used for sheet metal fabrication are not used on circuit boards because of the significant expense in handling and processing circuit board material. For example, to provide electrical connectivity, hole and component location is critical. Milling is often not accurate enough to provide the electrical connectivity between circuit board components and mounted components.

As can be understood, drills form only circular holes. Because of the circular configuration of the through holes formed in the printed circuit board, a mounted coupler, typically held by a threaded nut, can rotate within the drilled hole causing signal or electrical connectivity failure. To address this problem, some couplers are secured to the printed circuit board with a lock washer and nut. Even with lock washers and nuts, the couplers can loosen over time due to radial forces placed upon the couplers. In addition, because of the material characteristics of circuit boards, the boards have a tendency to shrink and further cause the couplers to loosen. Repair and maintenance of loosened couplers is costly, especially when a large number of couplers are positioned in arrays on a printed circuit board, or when the printed circuit board is secured to a chassis. In such arrangements, access to the coupler and loosened nut can be difficult, making repair and maintenance time consuming.

In general, improvement has been sought with respect to such arrangements, generally to better accommodate: ease of manufacture of printed circuit boards, ease of coupler and circuit board assembly, improved coupler location stability, and, adaptability for a variety of applications.

### SUMMARY

One aspect of the present disclosure relates to a printed circuit board arrangement having a non-metallic substrate defining a circular hole, and an adapter mounted to the substrate at the circular hole. The adapter includes mounting structure for mounting the adapter to the substrate at the circular hole. The adapter also includes a plate portion defining a non-circular opening, the non-circular opening being configured for receipt of a coupler. The coupler may be any type of coupler, including an optic coupler, such as a fiber optic adapter, or a copper coupler, such as a coaxial connector.

Another aspect of the present disclosure relates to a printed circuit board arrangement having a non-conductive substrate with electrical contacts for providing electrical communications. The printed circuit board also includes a conductive coupler mounting arrangement defining a non-circular through hole. The electrical contacts of the substrate provide a ground connection to a coupler when the coupler is mounted at the non-circular through hole.

Still another aspect of the present disclosure relates to a panel for mounting telecommunication couplers. The panel includes a non-conductive substrate having electrical contacts and a plurality of adapter pieces mounted to the substrate. The adapter pieces define connector mounting locations. Each of the adapter pieces includes a plate portion defining a non-circular opening and mounting structure to mount the adapter piece to the substrate. The panel also includes a plurality of couplers mounted to the substrate at the non-circular openings of the adapter pieces.

Yet another aspect of the present disclosure relates to an adapter for mounting a coupler to a printed circuit board. The adapter includes a plate portion having first and second opposing edges, a non-circular opening formed in the plate portion, and first and second tabs extending from respective first and second edges. The tabs are configured to mount the adapter to a printed circuit board.

Another aspect of the present disclosure relates to a method of manufacturing a printed circuit board. The method includes the steps of providing a printed circuit board that defines a circular hole and mounting an adapter at the circular hole. The adapter includes a non-circular opening for receipt of a coupler.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is an exploded, front perspective view of a printed circuit board showing a surface mounted arrangement, an insert, and a first adapter embodiment according to the principles of the present disclosure;

FIG. 2 is a rear perspective view of the first adapter of FIG. 1;

FIG. 3 is a rear perspective view of the insert of FIG. 1;

FIG. 4 is an assembled perspective view of FIG. 1;

FIG. 5 is a perspective view of FIG. 4, shown with the insert removed and shown with a coupler;

FIG. 6 is a perspective view of FIG. 5, shown with the coupler mounted to the printed circuit board;

FIG. 7 is an exploded, front perspective view of a printed circuit board showing one embodiment of a through-hole mount arrangement and a second adapter embodiment according to the principles of the present disclosure;

FIG. 8 is a rear perspective view of the second adapter of FIG. 7;

FIG. 9 is an assembled perspective view of FIG. 7;

FIG. 10 is a perspective view of FIG. 9, shown with a coupler mounted to the printed circuit board;

FIG. 11 is an exploded, front perspective view of a printed circuit board showing another embodiment of a through-hole mount arrangement and a third adapter embodiment according to the principles of the present disclosure;

FIG. 12 is a rear perspective view of the third adapter of FIG. 11;

FIG. 13 is an assembled perspective view of FIG. 11;

FIG. 14 is an exploded, front perspective view of a printed circuit board showing yet another embodiment of a through-hole mount arrangement and a fourth adapter embodiment according to the principles of the present disclosure;

FIG. 15 is a rear perspective view of the fourth adapter of FIG. 14;

FIG. 16 is an assembled perspective view of FIG. 14;

FIG. 17 is a rear perspective view of printed circuit boards incorporating each of the first through fourth adapter embodiments of FIGS. 6, 10, 13 and 16, including couplers;

FIG. 18 is an exploded, front perspective view of a printed circuit board showing another surface mounted arrangement, another insert, and a fifth adapter embodiment according to the principles of the present disclosure;

FIG. 19 is a rear perspective view of the fifth adapter of FIG. 18;

FIG. 20 is a rear perspective view of the insert of FIG. 18;

FIG. 21 is an assembled perspective view of FIG. 18;

FIG. 22 is a perspective view of FIG. 21, shown with the insert removed and shown with a coupler;

FIG. 23 is a perspective view of FIG. 22, shown with the coupler mounted to the printed circuit board;

FIG. 24 is an exploded, front perspective view of a printed circuit board showing another embodiment of a through-hole mount arrangement and a sixth adapter embodiment according to the principles of the present disclosure;

FIG. 25 is an exploded, front perspective view of a printed circuit board showing another embodiment of a through-hole mount arrangement and a seventh adapter embodiment according to the principles of the present disclosure;

FIG. 26 is an exploded, front perspective view of a printed circuit board showing another embodiment of a through-hole mount arrangement and an eighth adapter embodiment according to the principles of the present disclosure; and

FIG. 27 is a perspective view of a printed circuit board panel showing a plurality of couplers mounted to the panel according to the principles of the present disclosure.

### DETAILED DESCRIPTION

Reference will now be made in detail to various features of the present disclosure that are illustrated in the accompanying drawings. Wherever possible, the same reference numbers will be used throughout the drawings to refer to the same or like parts.

FIGS. 1-6 illustrate one embodiment of a coupler mounting arrangement 10 for use in mounting a coupler 12 to a printed circuit board 14. As shown in FIG. 1, the printed circuit board is generally a planar substrate 16. Preferably the substrate 16 is made of a non-metallic or non-conductive material. The planar substrate 16 has a first surface 18 and an opposite second surface 20. The printed circuit board 14 includes an electrical communication arrangement 26. The electrical communication arrangement 26 may include tracings 22 or electrical contacts 24, as shown in FIG. 1. In some embodiments, as described in greater detail hereinafter, the tracings 22 of the electrical communication arrangement 26 are, for example, a ground connection. That is, the electrical communication arrangement 26 provides electrical connections between the coupler 12 and ground. The electrical communication arrangements described herein are only examples of some of the electrical communication arrangement 26 that may be incorporated into the printed circuit board. A variety of tracing 22 and electrical contact 24 arrangements are possible for use in a variety of applications.

The printed circuit board 14 generally includes one or more circular holes or openings 28 (FIG. 1) formed through the planar substrate 16. The circular holes 28 are round or circular in shape, and typically formed by a drilling operation.

The coupler mounting arrangement 10 of the present disclosure provides a non-circular through hole 30 (FIG. 5) configured for receipt of the coupler 12. The coupler mounting arrangement 10 includes an adapter piece 32 (FIG. 1) that adapts the circular hole 28 formed in the printed circuit board 14 to the non-circular hole 30 for secure receipt of the coupler 12. That is, the circular hole 28 is adapted such that a coupler 12 received within the coupler mounting arrangement 10 is securely contained in a non-rotational orientation relative to the printed circuit board 14.

Because of the material characteristics of printed circuit boards, mechanical reinforcement is desirable. The adapter 32 of the coupler mounting arrangement 10 provides mechanical strength and stability at a location that experiences radial loading due to placement of the coupler 12.

Still referring to FIG. 1, the coupler mounting arrangement 10 shown is a surface mounting arrangement 34. The adapter piece 32 is configured to mount to the first surface 18 of the printed circuit board 14.

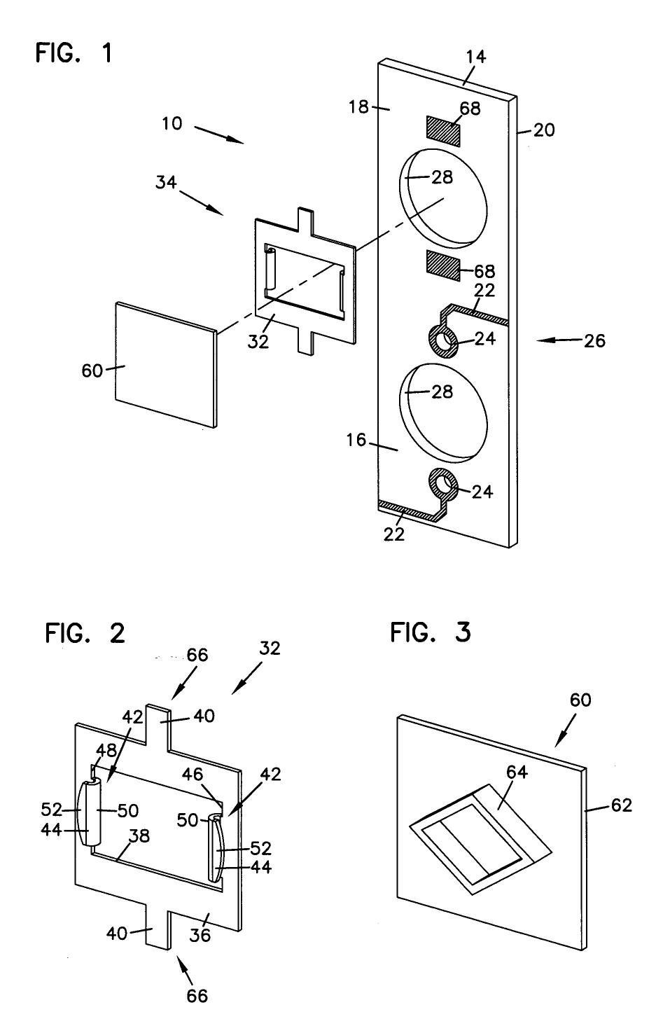

Referring now to FIG. 2, the adapter piece 32 generally includes a plate or frame 36 that defines a non-circular opening 38. The non-circular opening 38 can be any opening not having a complete circular cross-section. For example, the opening 38 may have a square, rectangular, or polygonal shape. The opening may be symmetrical in shape or non-symmetrical in shape. In addition, the non-circular opening may include a portion having a circular shape, but also includes a non-circular portion that prevents rotation of a coupler 12 within the non-circular opening 38. In the embodiment of FIGS. 1-6, the non-circular opening 38 has a rectangular shape.

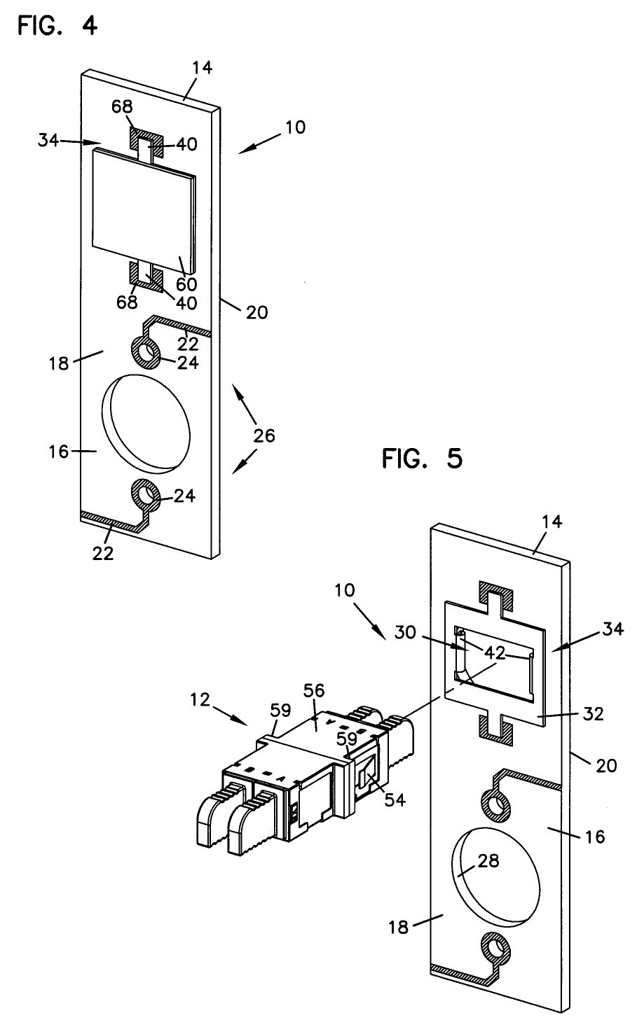

The adapter piece 32 of FIGS. 1-6 includes mounting structure 66 for mounting the adapter piece 32 to the printed circuit board 14. In the illustrated embodiment, the mounting arrangement 66 includes one or more tabs 40 extending outward from the frame 36. The tabs 40 shown in FIG. 2 are flat and extend straight out from the frame 36, i.e. the tabs 40 lie generally in the same plane as the frame 36. As shown in FIGS. 4-6, the tabs 40 are arranged to contact metallic solder pads 68 located on the printed circuit board. In the illustrated embodiment, at least the tabs 40 are made of a material to permit the adapter piece 32 to be soldered to the printed circuit board 14 at the solder pads 68. For example, the tabs 40 may be made of a material including a tin plating or tin lead plating, or made of other materials compatible with a soldering process. In the alternative, the adapter piece 32 may be mounted to the printed circuit board by other methods, such as by using a bonding agent, for example.

Referring back to FIG. 2, retaining structure 42 is positioned within the perimeter of the non-circular openings 38. The retaining structure 42 interconnects or contacts the coupler 12 to retain the coupler 12 within the non-circular opening 38 of the adapter piece 32.

In the illustrated embodiment, the retaining structure 42 includes retaining flanges 44 located at opposite sides 46, 48 of the opening 38 formed in the frame 36. The retaining flanges 44 include a rounded portion 50 and a bent portion 52. The rounded portion 50 acts as a spring to permit insertion of a coupler 12 within the opening 38 while providing some biasing force or interference to retain the coupler 12. The bent portion 52 secures the axial positioning of the coupler 12 by providing a snap-fit connection. In particular, the illustrated coupler 12 of FIG. 5 includes latch structures 54 (only one shown) and shoulders 59 formed in a housing 56. The bent portion 52 of the retaining structure 42 snap fits between the latch structure 54 and the shoulder 59 formed in the housing 56 to axially retain the coupler 12. The flanges 44 of the adapter piece 32 are also configured to provide a particular thickness to correspond to the space provided between the latch structure 54 and the shoulders 50 of the coupler housing 54.

Referring now to FIGS. 3 and 4, a plug or insert 60 is provided to assist in automated assembly of the adapter piece 32 to the printed circuit board 14. As shown in FIG. 3, the insert 60 has a base 62 and a projection 64 extending outward from the base 62. The projection 64 is positioned within the non-circular opening 38 formed in the adapter piece 32 to aid in handling the adapter piece. For example, during assembly, the insert 60 provides added surface area so that an automated vacuum pick-up operation can be used to handle and position the adapter 32.

In addition, the projection 64 is constructed to provide an interference fit when positioned within the circular hole 28 of the printed circuit board 14. That is, when the adapter 32 is located on the first surface 18 of the printed circuit board, the projection 64 of the insert 60 locates within the circular hole 28 and maintains the orientation and location of the adapter 32 while the adapter 32 is being mounted, i.e. soldered to the printed circuit board 14. In the illustrated embodiment, the projection 64 is diamond shaped. Other shaped and configured inserts may be used to ease assembly of the surface mounting arrangement 34 to the printed circuit board 14.

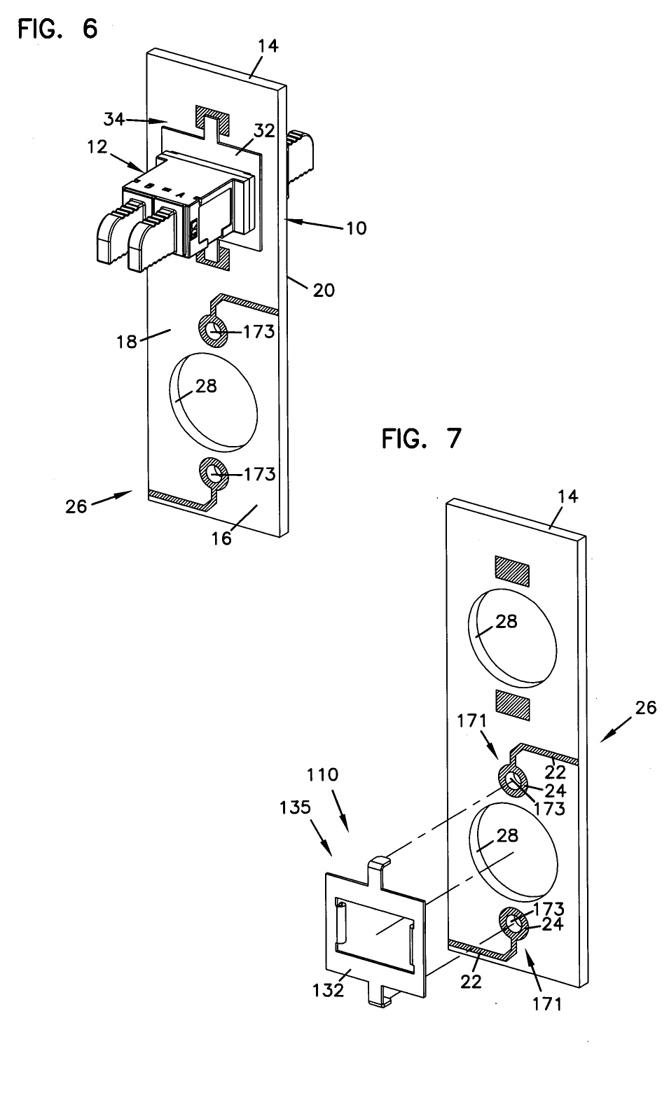

Referring now to FIG. 4, the coupler mounting arrangement 10 is shown assembled with the insert 60. The tabs 40 of the adapter piece 32 are soldered to the pads 68 of the printed circuit board 14. When the insert 60 is removed, the coupler 12 (FIG. 5) may be inserted into the non-circular opening 38 of the adapter piece 32. The latch structure 54 of the coupler housing 56 engages the retaining structure 42 of the adapter piece 32. When engaged, as shown in FIG. 6, the coupler 12 is axially and rotationally secured to the printed circuit board in a particular orientation. The non-circular through hole 30 of the coupler mounting arrangement 10 prevents any rotational movement of the coupler 12. In addition, the coupler mounting arrangement 10 retains the coupler to prevent unintended axial movement. What is meant by unintended axial movement is movement other than selected removal of the coupler 12. The coupler 12 is preferably constructed to be selectively inserted into and removed from the adapter piece 32 as needed. For example, the coupler 12 of FIGS. 5 and 6 can be removed from the coupler mounting arrangement 10 of the printed circuit board 14 by flexing the latch structure 54 of the coupler housing 56 to disengage the latch structure 54 from the retaining structure 42 of the adapter piece 32.

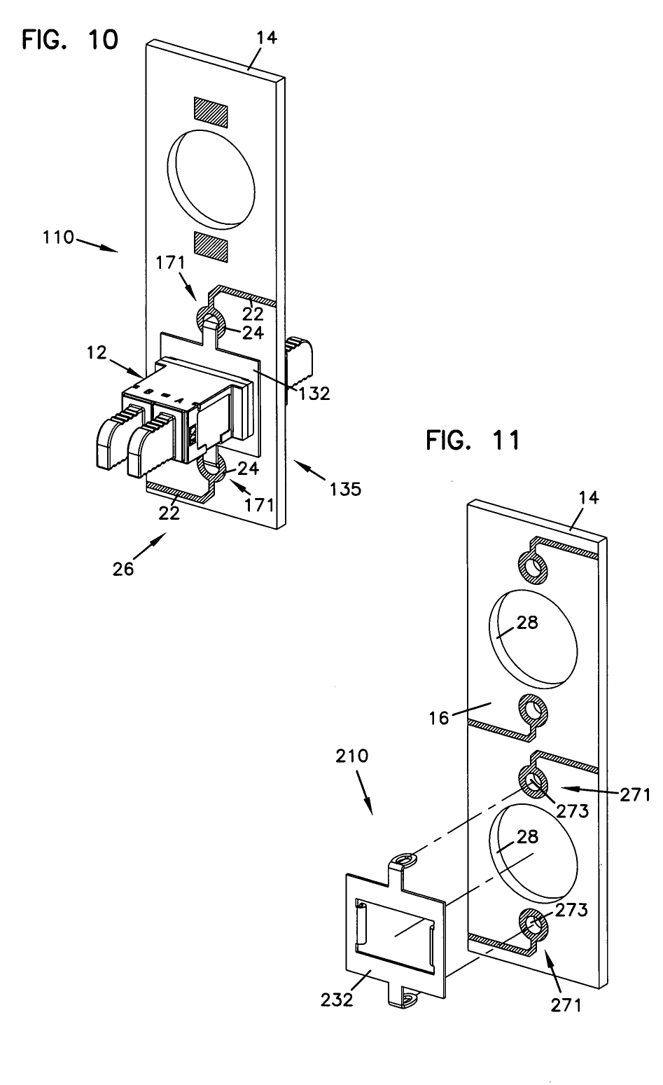

Referring now to FIGS. 7-10, a second coupler mounting arrangement 110 for use in mounting a coupler 12 to the printed circuit board 14 is illustrated. The second coupler mounting arrangement 110 of the present disclosure has similar features as the previous embodiment, including the non-circular through hole 30 (FIG. 9) configured for receipt of the coupler 12 (FIG. 10). In particular, the coupler mounting arrangement 110 includes an adapter piece 132 that adapts the circular hole 28 formed in the printed circuit board 14 to the non-circular hole 30 for secure receipt of the coupler 12.

The second coupler mounting arrangement 110 shown in FIGS. 7-10 is a through-hole mounting arrangement 135. That is, adapter piece 132 is configured to mount to board mount structure 171 formed in the printed circuit board 14. In the illustrated embodiment, the board mount structure 171 includes holes 173 formed within the substrate 16 of the printed circuit board 14.

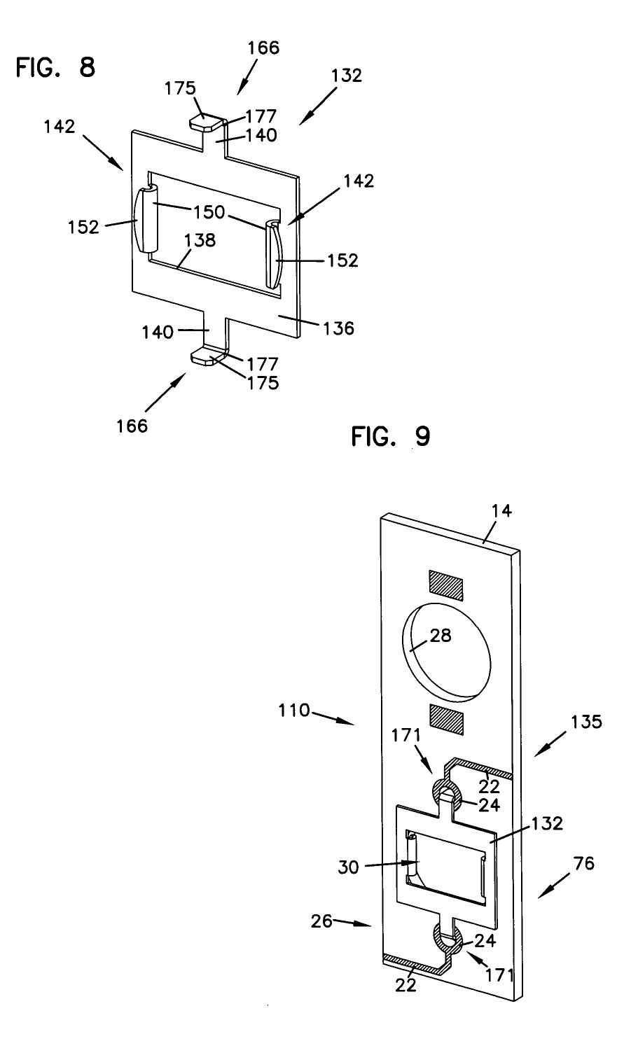

Referring now to FIG. 8, the adapter piece 132 generally includes a plate or frame 136 that defines a non-circular opening 138. In the embodiment of FIGS. 7-10, the non-circular opening 138 has a rectangular shape. The adapter piece 132 also includes mounting structure 166 for mounting the adapter piece 132 to the printed circuit board 14. In the illustrated embodiment, the mounting structure 166 includes one or more tabs 140 extending outward from the frame 136. The tabs 140 are flat and extend straight out from the frame 136.

The mounting structure 166 of the adapter piece 132 also includes a bent portion 175. The bent portion 175 extends at an angle from an end 177 of the tab 140. In the illustrated embodiment, the bent portion 175 is oriented generally 90 degrees from the tab 140. The bent portion 175 is arranged to interconnect to the board mount structure 171 of the printed circuit board 14. In particular, the bent portion 175 is arranged for receipt within the holes 173 formed in the printed circuit board 14. To secure the adapter piece 132, typically the bent portions 175 are soldered to the printed circuit board at the holes 173.

In some embodiments, the adapter piece of the coupler mounting arrangement is made of an electrically conductive material, such as plated beryllium, copper or phosphor bronze, for example. In the illustrated embodiment of FIGS. 7-10, the adapter piece 132 is preferably made of an electrically conductive material such that the bent portions 175 and/or tabs 140 provide electrical communication between the coupler 12 and a ground, for example. That is, the bent portions 175 contact the electrical contacts 24 of the electrical communication arrangement 26 to provide electrical connectivity between the contact 24 and ground via the tracings 22. By this, the adapter piece 132 is not only a structural mechanical connection, but also functions as an electrical connection.

Referring again to FIG. 8, retaining structure 142 is positioned within the perimeter of the non-circular openings 138 of the adapter piece 132. The retaining structure 142 includes retaining flanges having a rounded portion 150 and a bent portion 152 that secures the axial positioning of the coupler 12.

Referring now to FIG. 9, the second coupler mounting arrangement 110 is shown assembled to the printed circuit board 14. The bent portions 175 of the adapter piece 132 are electrically connected to the contacts 24 of the printed circuit board 14. As shown in FIG. 10, the coupler 12 may be inserted into the non-circular opening 138 of the adapter piece 132. The latch structure 54 (see FIG. 5) of the coupler housing 56 engages the retaining structure 142 of the adapter piece 132 to axially and rotationally secured the coupler 12 to the printed circuit board in a particular orientation. In addition, the second coupler mounting arrangement 110 retains the coupler to prevent unintended axial movement.

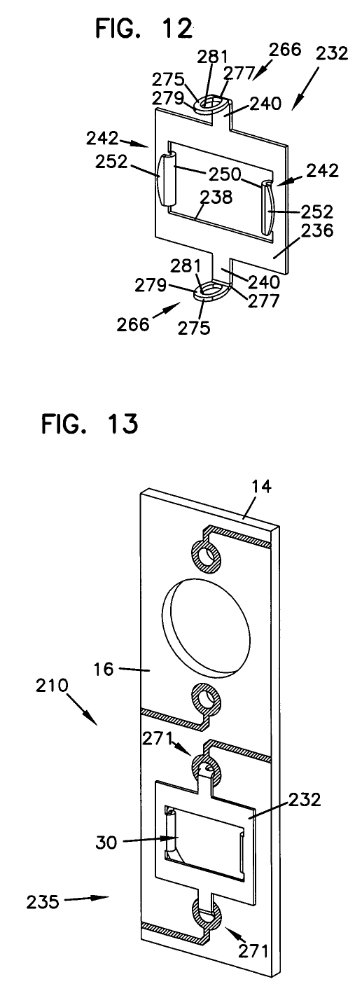

Referring now to FIGS. 11-13, a third coupler mounting arrangement 210 for use in mounting a coupler 12 to the printed circuit board 14 is illustrated. The third coupler mounting arrangement 210 of the present disclosure has similar features as the previous embodiments, including the non-circular through hole 30 (FIG. 13) configured for receipt of the coupler 12. In particular, the third coupler mounting arrangement 210 includes an adapter piece 232 that adapts the circular hole 28 formed in the printed circuit board 14 to the non-circular hole 30 for secure receipt of the coupler 12.

The third coupler mounting arrangement 210 shown in FIGS. 11-13 is a through-hole mounting arrangement 235. That is, the adapter piece 232 is configured to mount to board mount structure 271 formed in the printed circuit board 14. In the illustrated embodiment, the board mount structure 271 includes holes 273 formed within the substrate 16 of the printed circuit board 14.

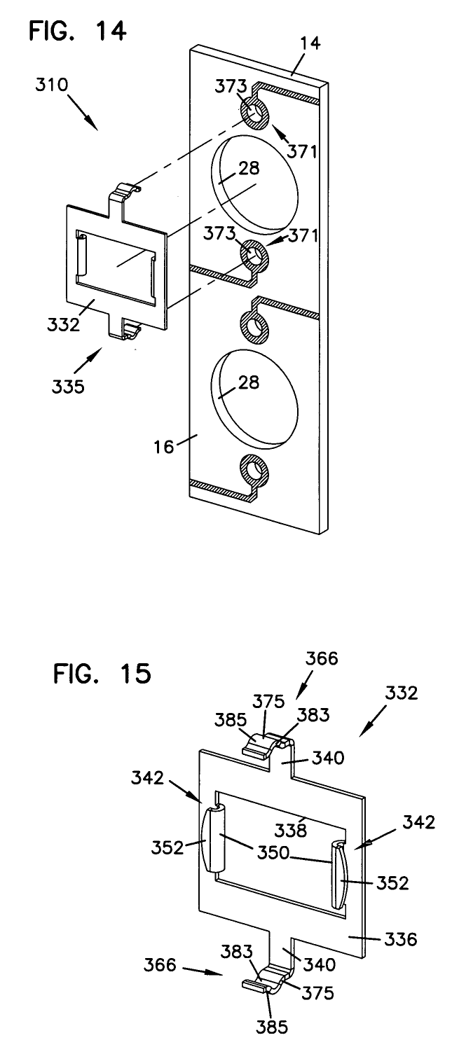

Referring now to FIG. 12, the adapter piece 232 generally includes a plate or frame 236 that defines a non-circular opening 238. In the embodiment of FIGS. 11-13, the non-circular opening 238 has a rectangular shape. The adapter piece 232 also includes mounting structure 266 for mounting the adapter piece 232 to the printed circuit board 14. In the illustrated embodiment, the mounting structure 266 includes one or more tabs 240 extending outward from the frame 236. The tabs 240 are flat and extend straight out from the frame 236.

The mounting structure 266 of the adapter piece 232 also includes a bent portion 275. The bent portion 275 extends at an angle from an end 277 of the tab 240. In the illustrated embodiment, the bent portion 275 is oriented generally 90 degrees from the tab 240. The bent portion 275 is arranged to interconnect to the board mount structure 271 of the printed circuit board 14. In particular, the bent portion 275 is arranged for receipt within the holes 273 of the printed circuit board 14.

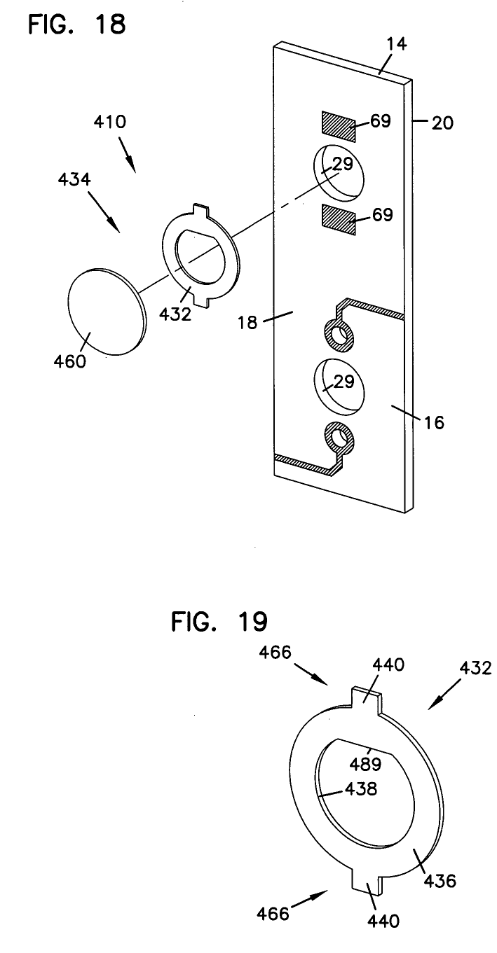

The bent portion 275 of the adapter piece 232 is configured as an eyelet 279 that defines an opening 281. The eyelet is designed to flex when initially inserted through the mounting hole 273 of the printed circuit board 14. As shown in FIGS. 13 and 17, the eyelet provides an interference fit that secures the adapter piece 232 to the board mount structure 271 of the printed circuit board 14. This configuration eliminates the need to soldering the adapter to the printed circuit board.

Similar to the previous embodiment, the adapter piece 232 may be made of an electrically conductive material. The bent portions 275 and/or tabs 240 then function to provide electrical communication between the coupler 12 and a ground, for example.

Referring again to FIG. 12, retaining structure 242 is positioned within the perimeter of the non-circular openings 238 of the adapter piece 232. The retaining structure 242 includes retaining flanges having a rounded portion 250 and a bent portion 252 that secures the axial positioning of the coupler 12.

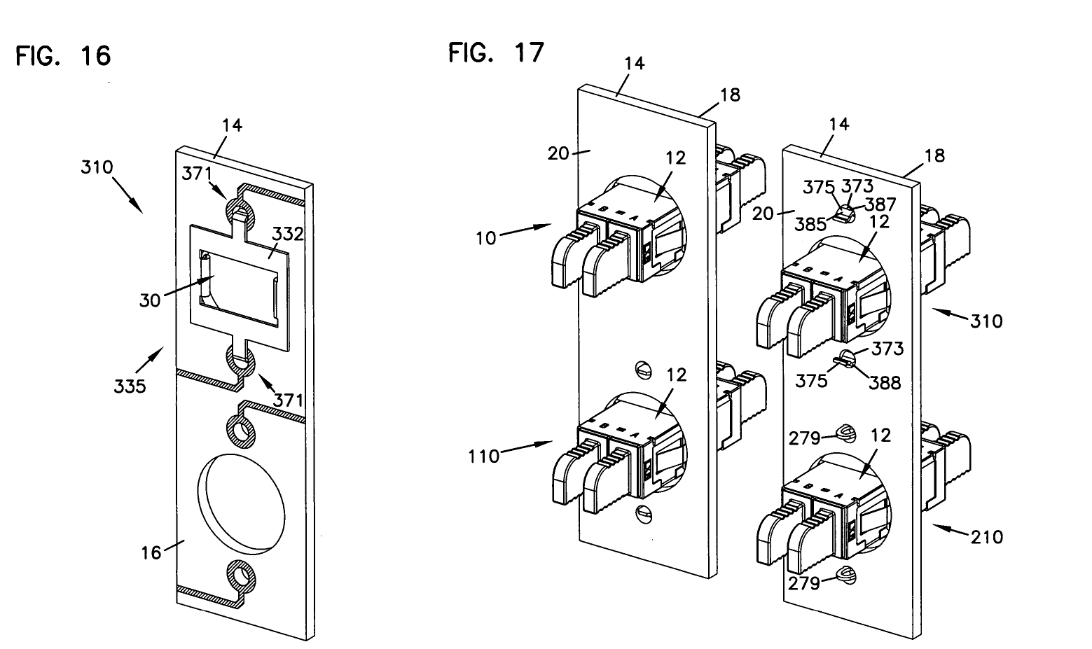

Referring now to FIGS. 14-16, a fourth coupler mounting arrangement 310 for use in mounting a coupler 12 to the printed circuit board 14 is illustrated. The fourth coupler mounting arrangement 310 of the present disclosure has similar features as the previous embodiments, including the non-circular through hole 30 (FIG. 16) configured for receipt of the coupler 12. In particular, the fourth coupler mounting arrangement 310 includes an adapter piece 332 that adapts the circular hole 28 formed in the printed circuit board 14 to the non-circular hole 30 for secure receipt of the coupler 12.

The fourth coupler mounting arrangement 310 shown in FIGS. 14-16 is a through-hole mounting arrangement 335. That is, adapter piece 332 is configured to mount to board mount structure 371 formed in the printed circuit board 14. In the illustrated embodiment, the board mount structure 371 includes holes 373 formed within substrate 16 of the printed circuit board 14.

Referring now to FIG. 15, the adapter piece 332 generally includes a plate or frame 336 that defines a non-circular opening 338. The adapter piece 332 also includes mounting structure 366 for mounting the adapter piece 332 to the printed circuit board 14. In the illustrated embodiment, the mounting structure 366 includes one or more tabs 340 extending outward from the frame 336. The tabs 340 are flat and extend straight out from the frame 336.

The mounting structure 366 of the adapter piece 332 also includes a bent portion 375. The bent portion 375 extends at an angle of generally 90 degrees from the tab 340. The bent portion 375 is arranged to interconnect to the board mount structure 371 of the printed circuit board 14. In particular, the bent portion 375 is arranged for receipt within the holes 373 of the printed circuit board 14.

The bent portion 375 of the adapter piece 332 is configured as snap-fit type connection having a crimped arrangement 383. The crimped arrangement 383 clips or snaps within the mounting holes 373 of the printed circuit board 14. When initially inserted within the mounting holes 373, front ramp portions 385 of the crimped arrangement 283 contact edges of the mounting holes 373 to flex the bent portions 375 toward one another. As shown in FIG. 17, when the adapter piece 332 is complete inserted within the mounting holes 373, the bent portions 375 re-expand and rear ramp portions 387 engage the perimeter of the holes 373 adjacent to the second surface 20 of the printed circuit board to secure the adapter piece 332 to the printed circuit board 14. This configuration eliminates the need to solder the adapter to the printed circuit board.

Similar to the previous embodiment, the adapter piece 332 may be made of an electrically conductive material. The bent portions 375 and/or tabs 340 then function to provide electrical communication between the coupler 12 and a ground, for example.

Referring again to FIG. 15, retaining structure 342 is positioned within the perimeter of the non-circular openings 338 of the adapter piece 332. The retaining structure 342 includes retaining flanges having a rounded portion 350 and a bent portion 352 that secures the axial positioning of the coupler 12.

In each of the embodiment of FIGS. 1-17, the coupler mounting arrangement is configured for receipt of an optic coupler 12, such as a fiber optic adapter. In accord with the principles of the present disclosure, similar mounting arrangement can be used with other couplers, such as copper couplers, including coaxial connectors.

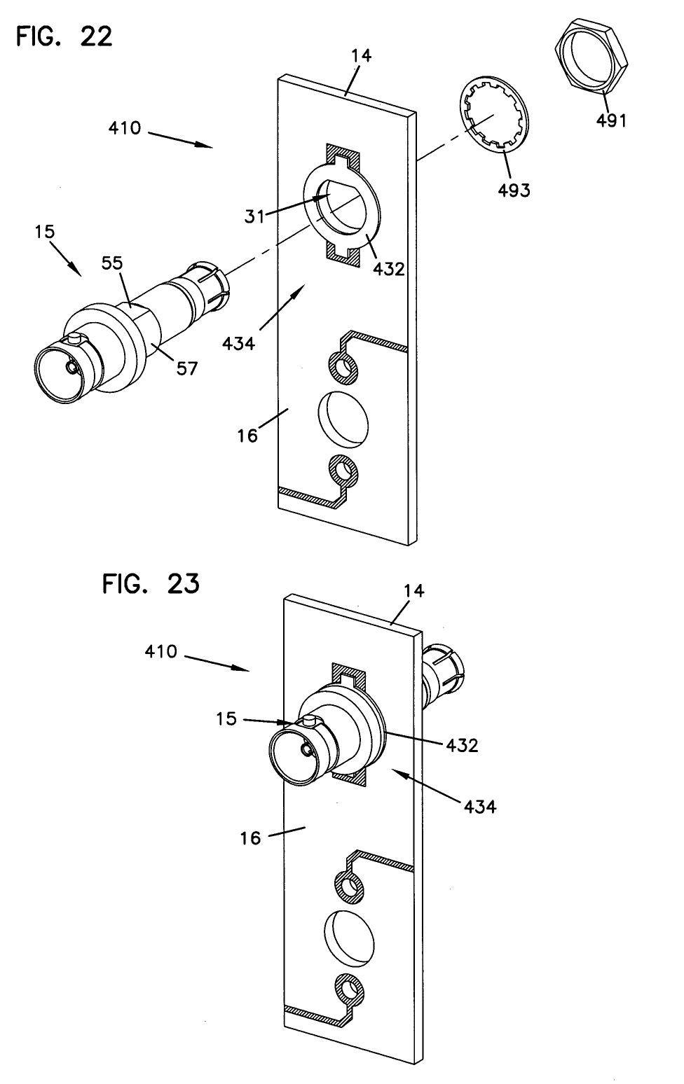

Referring now to FIGS. 18-23, a fifth embodiment of a coupler mounting arrangement 410 for use in mounting a copper coupler 15 (FIGS. 22 and 23) to a printed circuit board 14 is illustrated. The fifth coupler mounting arrangement 410 of the present disclosure provides a non-circular through hole 31 (FIG. 22) configured for receipt of the coupler 15. The coupler mounting arrangement 410 includes an adapter piece 432 that adapts a circular hole 29 (FIG. 18) formed in the printed circuit board 14 to the non-circular hole 31 for secure receipt of the coupler 15. That is, the circular hole 29 is adapted such that a coupler 15 received within the coupler mounting arrangement 410 is securely contained in a non-rotational orientation relative to the printed circuit board 14.

Still referring to FIG. 18, the coupler mounting arrangement 410 shown is a surface mounting arrangement 434. The adapter piece 432 is configured to mount to the first surface 18 of the printed circuit board 14.

Referring now to FIG. 19, the adapter piece 432 generally includes a plate or frame 436 that defines a non-circular opening 438. The non-circular opening 438 can be any opening not having a complete circular cross-section. In the illustrated embodiment, the non-circular opening 438 includes a portion having a circular shape, but including a non-circular portion or flat 489 that prevents rotation of a coupler 15 within the non-circular opening 438.

The adapter piece 432 of FIGS. 18-23 includes mounting structure 466 for mounting the adapter piece 432 to the printed circuit board 14. In the illustrated embodiment, the mounting structure 466 includes one or more tabs 440 extending outward from the frame 436. The tabs 440 shown in FIG. 19 are flat and extend straight out from the frame 36, i.e. the tabs 440 lie generally in the same plane as the frame 436. The tabs 440 are arranged to contact solder pads 69 located on the printed circuit board. In the illustrated embodiment, the tabs 440 are soldered to the printed circuit board 14 at the solder pads 69.

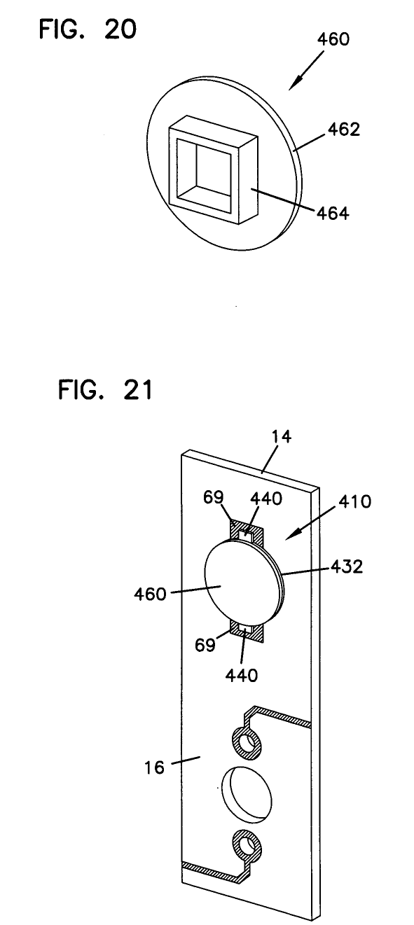

Referring now to FIGS. 18 and 20, a plug or insert 460 may be used to assist in automated assembly of the adapter piece 432 to the printed circuit board 14. As shown in FIG. 20, the insert 460 has a base 462 and a projection 464 extending outward from the base 462. The projection 464 is positioned within the non-circular opening 438 formed in the adapter piece 432 to aid in handling the adapter piece. In the illustrated embodiment, the projection 464 is square shaped and configured to fit within the circular opening 29 formed in the printed circuit board, as previously described. Other shaped and configured inserts may be used to ease assembly of the surface mounting arrangement 434 to the printed circuit board 14.

Referring now to FIG. 21, the coupler mounting arrangement 410 is shown with the insert 460. The tabs 440 of the adapter piece 432 are soldered to the solder pads 69 of the printed circuit board 14. When the insert 460 is removed, the coupler 15 (FIG. 22) may be inserted into the non-circular opening 438 of the adapter piece 432. Hardware, such as a nut 491 and lock washer 493, is used to axially secure the coupler 15 in relation to the printed circuit board. The coupler 15 is rotationally secured in relation to the printed circuit board in a particular orientation by the flat 489 formed in the non-circular opening 438. In particular, the flat 498 of the coupler mounting arrangement 410 corresponds to a flat 55 formed on a housing 57 of the coupler 15. When the coupler 15 is mounted within the non-circular through hole 31 of the coupler mounting arrangement 410, the non-circular hole 31 prevents any rotational movement of the coupler 15.

As can be understood, the non-circular opening 438 of the adapter 432 may be configured to require insertion of the coupler in only one particular angular orientation. For example, the non-circular opening 31 may be asymmetrically configured so that the coupler 15 can be inserted in only one angular orientation. In the illustrated embodiment, the flat 489 requires a user to correspondingly orient the coupler 15 so that the coupler can only be mounted to the printed circuit board in a particular orientation. This feature can be used to better organize and manage couplers as well as avoid damage caused by coupler rotation.

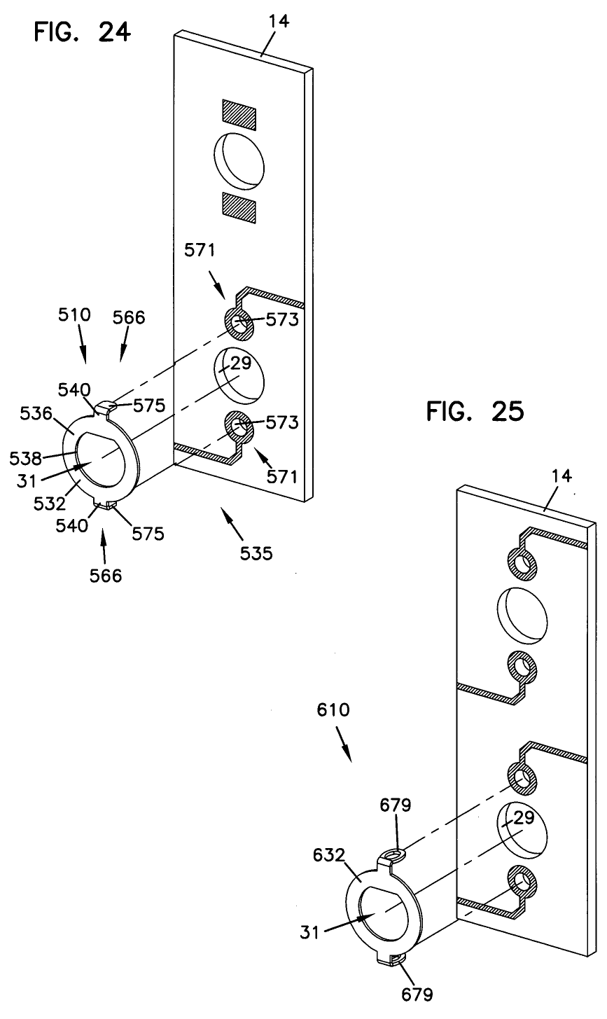

Referring now to FIG. 24, a sixth coupler mounting arrangement 510 for use in mounting a coupler 15 (see FIG. 22) to the printed circuit board 14 is illustrated. The sixth coupler mounting arrangement 510 of the present disclosure has similar features as the previous embodiment, including the non-circular through hole 31 configured for receipt of the coupler 15. In particular, the coupler mounting arrangement 510 includes an adapter piece 532 that adapts the circular hole 29 formed in the printed circuit board 14 to the non-circular hole 31 for secure receipt of the coupler 15.

The sixth coupler mounting arrangement 510 is a through-hole mounting arrangement 535. That is, adapter piece 532 is configured to mount to board mount structure 571 formed in the printed circuit board 14. In the illustrated embodiment, the board mount structure 571 includes holes 573 formed within substrate 16 of the printed circuit board 14.

The adapter piece 532 generally includes a plate or frame 536 that defines a non-circular opening 538. The adapter piece 532 also includes mounting structure 566 for mounting the adapter piece 532 to the printed circuit board 14. In the illustrated embodiment, the mounting structure 566 includes one or more tabs 540 extending outward from the frame 536. Similar to the embodiment of FIGS. 7-10, the mounting structure 566 of the adapter piece 532 also includes bent portions 575 arranged for receipt within mounting holes 573 formed in the printed circuit board 14.

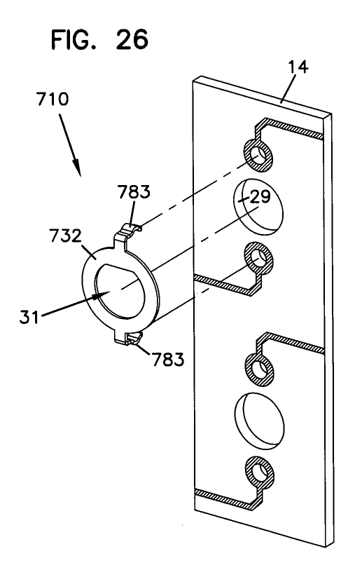

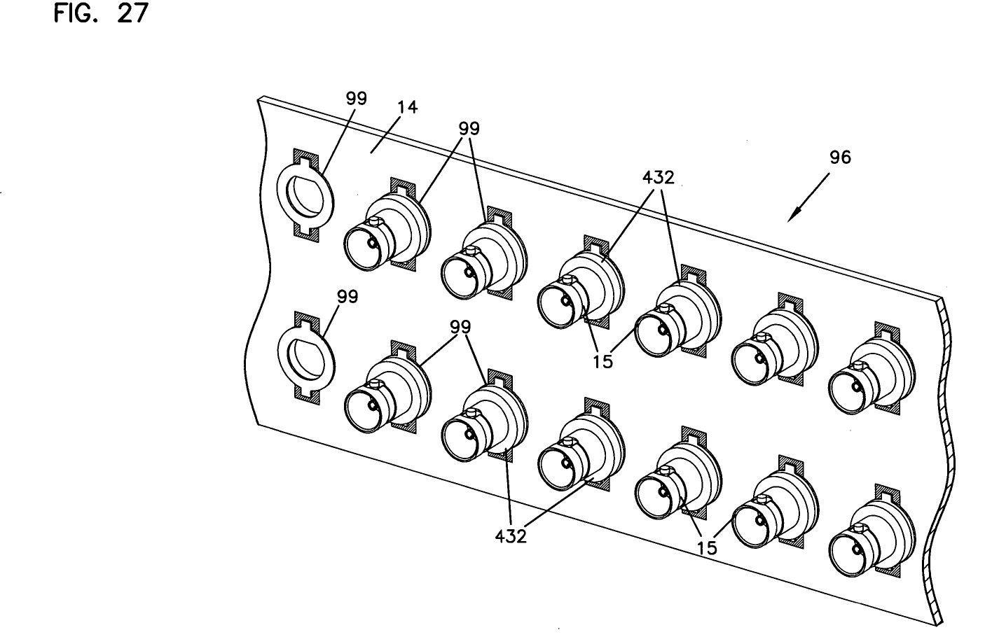

Referring now to FIGS. 25 and 26, seventh and eighth embodiments of a coupler mounting arrangement 610, 710 for use in mounting a coupler 15 to the printed circuit board 14 are illustrated. Each of the coupler mounting arrangements 610, 710 have similar features as the previous embodiments, including the non-circular through hole 31 configured for receipt of the coupler 15 (shown in FIGS. 22 and 23). The seventh coupler mounting arrangement 610 has an adapter 632 configured with an eyelet 679 similar to that of the embodiment shown in FIGS. 11-13. The eighth coupler mounting arrangement 710 has an adapter 732 configured with a crimped arrangement 783 similar to that of the embodiment shown in FIGS. 14-16.

As can be understood, each of the adapters 632 and 732 are configured to provide electrical communication as previously described, and adapts the circular hole 29 formed in the printed circuit board 14 to the non-circular hole 31 for axially and rotationally securing the coupler 15 to the printed circuit board 14.

Referring now to FIG. 27, each of the coupler mounting arrangement previously described can be provided on a printed circuit board 14 to define a panel 96 having an array or a plurality of coupler mounting locations 99. Although only two rows of coupler mounting locations 99 and couplers are shown, the panel can include a number of rows and/or columns. The panel 96 illustrated shows copper coupler mounting arrangements 432, although the panel 96 can include any of the embodiments of coupler mounting arrangements for either or both of the optic or copper couplers. Preferably, each of the coupler mounting arrangements is similarly oriented, as shown by the two open coupler mounting locations. By this, the couplers 15 are correspondingly oriented when mounted to the panel 96, and uniformly positioned relative to one another to provide an organized array of mounted couplers 15. The panel 96 can be configured to mount within a chassis (not shown).

The above specification provides a complete description of the present invention. Since many embodiments of the invention can be made without departing from the spirit and scope of the invention, certain aspects of the invention reside in the claims hereinafter appended.

1. A printed circuit board arrangement, comprising:
a) a non-metallic substrate defining a circular hole; and
b) an adapter mounted to the substrate at the circular hole, the adapter including:
i) a plate portion defining a non-circular opening, the non-circular opening being configured for receipt of a coupler;
ii) mounting structure for mounting the adapter to the substrate at the circular hole; and
c) a fiber optic coupler mounted to the substrate by the adapter.

2. The arrangement of claim 1, wherein the mounting structure includes at least one tab extending from the plate portion of the adapter.

3. The arrangement of claim 2, wherein the tab of the mounting structure is soldered to a pad located on a surface of the printed circuit board.

4. The arrangement of claim 2, wherein the mounting structure further includes a bent portion extending from an end of the tab, the bent portion being arranged for receipt within a mounting hole formed in the printed circuit board.

5. The arrangement of claim 4, wherein the bent portion of the tab extends through the mounting hole and is soldered to the printed circuit board at the mounting hole.

6. The arrangement of claim 4, wherein the bent portion of the tab is sized to provide an interference fit in relation to the mounting hole to secure the adapter to the printed circuit board.

7. The arrangement of claim 4, wherein the bent portion includes a flexible eyelet that flexes when initially inserted through the mounting hole.

8. The arrangement of claim 4, wherein the bent portion includes a crimped arrangement that clips within the mounting hole to secure the adapter to the printed circuit board.

9. The arrangement of claim 1, wherein the non-circular opening is rectangular to prevent rotation of the fiber optic coupler received within the non-circular opening of the adapter.

10. (canceled)

11. The arrangement of claim 1, further including retaining structure located within a perimeter of the non-circular opening, the retaining structure being configured to engage the coupler to axially retain the coupler received within the non-circular opening of the adapter.

12. (canceled)

13. (canceled)

14. (canceled)

15. The arrangement of claim 1, further including a plurality of adapters mounted to the substrate at each of a plurality of circular holes, the plurality of adapters defining arrays of coupler mounting locations.

16. The arrangement of claim 15, further including a plurality of fiber optic couplers mounted to the substrate by the plurality of adapters.

17. A printed circuit board arrangement, comprising:
a) a non-conductive substrate including:
i) electrical contacts for providing electrical communications; and
ii) a plurality of conductive coupler mounting arrangements defining non-circular through holes, each of the non-circular through holes being similarly oriented: and
b) a plurality of optic couplers mounted to the non-conductive substrate;
c) wherein the electrical contacts provide a ground connection to the optic couplers when the couplers are is mounted at the non-circular through holes.

18. (canceled)

19. (canceled)

20. (canceled)

21. (canceled)

22. A panel for mounting telecommunication couplers, the panel including:
a) a non-conductive substrate having electrical contacts;
b) a plurality of adapter pieces mounted to the substrate to define a plurality of connector mounting locations, each of the adapter pieces including:
i) a plate portion defining a non-circular opening, the non-circular opening being configured for receipt of a coupler; and
ii) mounting structure for mounting the adapter piece to the substrate; and
c) a plurality of fiber optic couplers mounted to the substrate at the non-circular openings of the adapter pieces.

23. The panel of claim 22, wherein the non-conductive substrate defines a plurality of circular openings, of the adapter pieces being mounted to cover the circular openings such that the non-circular openings define a non-circular through holes configured for receipt of the couplers.

24. The panel of claim 22, wherein the non-conductive substrate further includes electrical tracings to provide electrical connections between one or more of the plurality of couplers and ground.

25. The panel of claim 22, wherein the non-conductive substrate further includes solder pads for mounting the plurality of adapter pieces to the substrate.

26. The panel of claim 22, wherein each of the plurality of adapter pieces includes tabs that interlock with the non-conductive substrate.

27. An adapter for mounting a coupler to a printed circuit board, the adapter comprising:
a) a plate portion having first and second opposing edges;
b) a non-circular opening formed in the plate portion, the non-circular opening having a D-shape that prevents rotation of a coaxial connector when mounted within the non-circular opening; and
c) first and second tabs extending from respective first and second edges, the tabs being configured to mount the adapter to a printed circuit board.

28. The adapter of claim 27, further including bent portions extending from an end of each of the tabs.

29. The adapter of claim 28, wherein the bent portions of the tabs are sized to provide an interference fit with mounting hole formed in the printed circuit board to mount the adapter to the printed circuit board.

30. The adapter of claim 28, wherein the bent portion includes a flexible eyelet.

31. The adapter of claim 28, wherein the bent portion includes a crimped arrangement.

32. (canceled)

33. (canceled)

34. (canceled)

35-43. (canceled)

44. A printed circuit board arrangement, comprising:
a) a non-metallic substrate defining a circular hole;
b) an adapter mounted to the substrate at the circular hole, the adapter including:
i) a plate portion defining a non-circular opening, the non-circular opening being configured for receipt of a connector; and
ii) mounting structure for mounting the adapter to the substrate at the circular hole; and
c) a coaxial connector mounted to the substrate by the adapter.

45. The arrangement of claim 44, wherein the mounting structure includes at least one tab extending from the plate portion of the adapter.

46. The arrangement of claim 45, wherein the tab of the mounting structure is soldered to a pad located on a surface of the printed circuit board.

47. The arrangement of claim 45, wherein the mounting structure further includes a bent portion extending from an end of the tab, the bent portion being arranged for receipt within a mounting hole formed in the printed circuit board.

48. The arrangement of claim 47, wherein the bent portion of the tab extends through the mounting hole and is soldered to the printed circuit board at the mounting hole.

49. The arrangement of claim 47, wherein the bent portion of the tab is sized to provide an interference fit in relation to the mounting hole to secure the adapter to the printed circuit board.

50. The arrangement of claim 47, wherein the bent portion includes a flexible eyelet that flexes when initially inserted through the mounting hole.

51. The arrangement of claim 47, wherein the bent portion includes a crimped arrangement that clips within the mounting hole to secure the adapter to the printed circuit board.

52. The arrangement of claim 44, wherein the non-circular opening includes a flat portion to prevent rotation of the coaxial connector received with the non-circular opening of the adapter.

53. The arrangement of claim 1, further including a plurality of adapters mounted to the substrate at each of a plurality of circular holes, the plurality of adapters defining arrays of coupler mounting locations.

54. The arrangement of claim 15, further including a plurality of coaxial connectors mounted to the substrate by the plurality of adapters.

55. A printed circuit board arrangement, comprising:
a) a non-metallic substrate defining a circular hole; and
b) an adapter mounted to the substrate at the circular hole, the adapter including:
i) a plate portion defining a non-circular opening, the non-circular opening being configured for receipt of a coupler; and
ii) mounting structure for mounting the adapter to the substrate at the circular hole, the mounting structure including a tab and a bent portion, the tab extending from the plate portion of the adapter, the bent portion extending from an end of the tab, the bent portion being arranged for receipt within a mounting hole formed in the printed circuit board, wherein the bent portion includes a flexible eyelet that flexes when initially inserted through the mounting hole.

56. A printed circuit board arrangement, comprising:
a) a non-conductive substrate including:
i) electrical contacts for providing electrical communications; and
ii) a plurality of conductive coupler mounting arrangements defining non-circular through holes, each of the non-circular through holes being similarly oriented; and
b) a plurality of coaxial couplers mounted to the non-conductive substrate;
c) wherein the electrical contacts provide a ground connection to the coaxial couplers when the couplers are mounted at the non-circular through holes.

57. A panel for mounting telecommunication couplers, the panel including:
a) a non-conductive substrate having electrical contacts;
b) a plurality of adapter pieces mounted to the substrate to define a plurality of connector mounting locations, each of the adapter pieces including:
i) a plate portion defining a non-circular opening, the non-circular opening being configured for receipt of a connector; and
ii) mounting structure for mounting the adapter piece to the substrate; and
c) a plurality of coaxial connectors mounted to the substrate at the non-circular openings of the adapter pieces.
